(19) United States
(12) Patent Application Publication
(10) Pub. No.: US 2004/0081319 A1
(43) Pub. Date: Apr. 29, 2004

(54) Check verification and authentication process and apparatus

(76) Inventor: Ned W. Berg, Flower Mound, TX (US)

Correspondence Address: John E. Vandigriff, Suite 200, 190 N. Stemmons Frwy., Lewisville, TX, 75067, US

(21) Appl. No.: 10/685,216

(22) Filed: Oct. 14, 2003

Related U.S. Application Data
(63) Continuation-in-part of application No. 09/460,445, filed on Dec. 13, 1999, now abandoned.

(51) Int. Cl. H04N 7/167

(52) U.S. Cl. 380/201

(57) ABSTRACT

The invention uses a highly sophisticated process to decode and potentially display information contained in the non-visible multi-dimensional properties placed on a document. A standard reader/decoder, the reader modified with a correction lens and filter, unit captures the multi-dimensional properties using a special light source and decoding the multi-dimensional property. Then making the decoded information immediately available for the recipient of the document to determine fraud or tampering makes the present invention unique. Unlike other processes and detection methods validating paper on the document, the invention protects the original document data content.

### RELATED APPLICATIONS

This is a continuation in part of U.S. patent application Ser. No. 09/460,445, entitled CHECK VERIFICATION AND AUTHENTICATION PROCESS AND APPARATUS.

### FIELD OF THE INVENTION

The invention relates to document reading/decoding apparatus and a method of encoding documents, including checks and currency with a multidimensional bar code using fluorescent ink or non-visible inks to encode the payee and payer on checks, those person authorized to sign the check, which protects the payee and payor of the check, but not the authentication of the paper. This is accomplished utilizing a unique reading device, which allows the reading/decoding of a non-visible multidimensional bar code.

### BACKGROUND OF THE INVENTION

Currently Corporations, Banks and other Financial Institutions are suffering severe losses due to fraudulent and counterfeit check cashing and fraudulent tampering with documents lacking security features. In order to combat this problem many of these institutions are focusing their attention to evaluating and analyzing non-visible ink encryption technology. American Express Travelers Checks, International Currency, International Lunch Voucher Coupons all contain within the paper stock some form of non-visible ink security properties. Until now detection of these properties were limited to pattern design and light intensity recognition. The recognition devices would be pre-programmed to recognize both the design pattern and the light intensity of that pattern in order to authenticate a positive match. This verification process is: (a) very time consuming; (b) Requires specialized equipment to read and interpret the information; (c) Extremely limited in the amount of information and data to be read; (d) in many cases insufficient to provide a positive authentication.

Other methods addressing fraudulent checks can be costly and burdened with creating images of individuals pictures and marks visible and invisible on checks.

An example is U.S. Pat. No. 5,838,814 to Moore describes such methods using photographs and “made payable codes” and “endorsement codes”.

U.S. Pat. No. 5,537,486 to Stratigos et al. describes utilization of a printed pattern having a predetermined arrangement of different reflectivity due to varying densities, line resolutions, or fluorescence. A graphic image is produced by the scanner and then sent to a comparison unit, hardware, and then to an operators workstation for visual comparison of the image. This process is time consuming and creates traffic on interactive computer links to host computers and servers. The verification process of the present invention does not use optical scanning techniques to detect subtle variations in patterns printed on documents.

U.S. Pat. No. 5,326,136 to Doyle, uses special inks to determine if a check has been removed out of order from a check book. This process only relates to out of order check removal from a check book and does not address checks removed in order and does not afford security beyond removal.

U.S. Pat. No. 5,109,153 to Johnsen et al. describes a process where inks in a specific wave length range or sensitivity are utilized with a cancellation device for voiding documents of the invention with a scanner, a comparator and a radiant energy source for exposing the document to activate the energy responsive material on the document. This patent addresses utilization of inks and dyes to for flash imaging and voidable articles.

U.S. Pat. No. 5,917,925 to Moore describes a method for US Postal tracking and verification. Indicia marks are used to reduce problems associated with counterfeiting of mail piece indicia and mail piece diversion. This process utilized host computers to control and audit the printing of indicia marks on mail pieces. This process is associated with marks placed on mail pieces and the mark is read and passed onto a host computer wherein the now ASCII data is compared to the ASCII data residing on the host computer for verification and validation.

U.S. Pat. No. 5,867,586 to Liang describes a process and apparatus for fluorescent imaging, scanning and optical character reading. The authentication system described can operate in conjunction with a process for marking articles with indicia selected from a predetermined set of graphic images and characters readable by optical character recognition and/or image compression. This can be done in the visible or non-visible spectrum.

### SUMMARY OF THE INVENTION

The invention uses a highly sophisticated process to decode and potentially display information contained in the non-visible multi-dimensional properties placed on a document. A standard barcode reader modified with a correction lens and filter captures the multi-dimensional properties, using a special light source and decodes the multi-dimensional property. The decoded information is immediately available for the recipient of the document to determine fraud or tampering makes the present invention unique.

By using non-visible ink technology, with the utilization of high compression, multi-dimensional bar codes within the parameters of a check or any document requiring security, these institutions can now achieve the additional levels of security and office automation required and at the same time reduce or eliminate the need to reference back to a signature card database on line. In this situation, an image of the signature would be embedded into the check or secure document for quick decoding and authentication at the teller workstation. This process: (a)reduces or eliminate the transmission and data research time necessary to approve these documents; (b) reduces or eliminates the majority of back office personal in the signature authorization department; (c) reduces the wait time for high profile clients; and (d) reduces bank teller lines. On checks, the “Pay to the Order” entry/name could be protected as a second level of authentication to prevent the “bleaching out of the original entry with a fraudulent name”.

### BRIEF DESCRIPTIONS OF THE DRAWINGS

FIG. 1 shows the Multi-dimensional properties printed on the front a check;

FIG. 2 shows the Multi-dimensional properties printed on the back of a check;

FIG. 3 shows the process and apparatus that authenticates the security of the Pay to field of the check and reads the check information;

FIG. 4 shows the process and apparatus that authenticates the security of the signature on the check;

FIG. 5 shows the reader, lense and filter required to read the two-dimensional barcode in a standard barcode reader; and

FIG. 6 shows a stand-alone multi-dimensional property reader and light to illuminate and render the non-visible property visible.

### DESCRIPTION OF A PREFERRED EMBODIMENT

The invention incorporates a device which until now has never been integrated into a reader/decoder for non-visible multi-dimensional bar code device capable of reading/decoding this property. By utilizing this technology, banks and financial institutions will be capable of deterring fraud at the point of capture or receipt. Retail and Wholesale stores will reduce or eliminate fraudulent or counterfeit checks before the perpetrator has committed the crime.

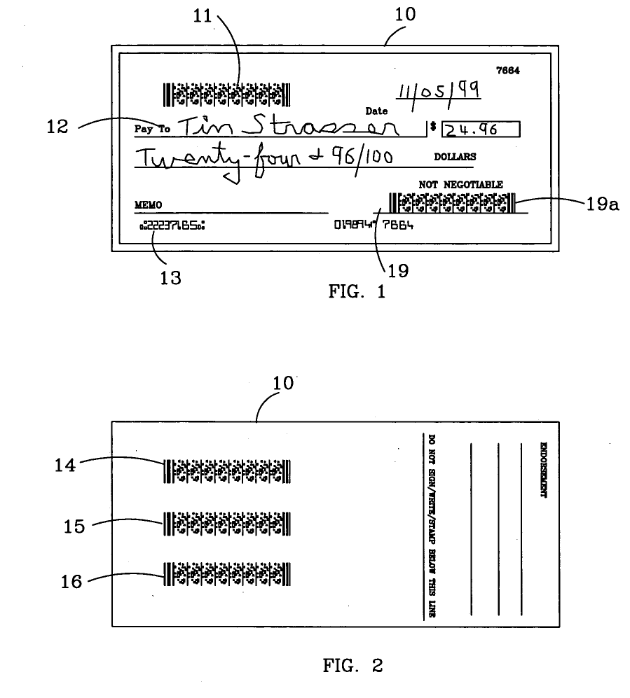

A bank, financial institution or any establishment, which produces documents, will be able to utilize the following methodology to further enhance and secure valuable documents. A check 10 according to the invention is shown in FIG. 1 and FIG. 2. Checks or documents maybe encrypted as follows. For Corporate, Government and special checks, the “Pay to” field 12, or any other area, includes an area 11 where fluorescent (non-visible ink) is imprinted. Within the ink a duplicate name of the “Pay to” is encrypted in a multi-dimensional bar code. In the signature field area 19 on the front of the document a duplicate signature of the “owner or owners” of the document is imprinted in fluorescent or non-visible ink 19a and encrypted in a multi-dimensional bar code format. On the backside of check 10. A duplicate signature of the “owner or owners” of the document is imprinted in fluorescent or non-visible ink and encrypted in a multi-dimensional bar code format 14, 15 and 16. In the example of FIG. 2, three persons may sign the check. This may vary, according to the number of person authorized to sign the check. Alternately, other information may be in the non-visible multidimensional bar code to product date integrity.

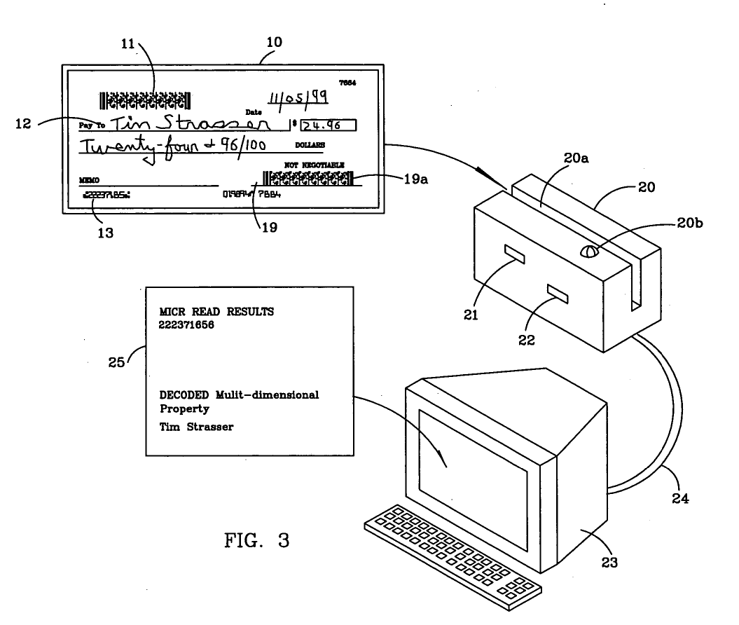

In FIG. 3, a reader/decoder 20 is shown that includes a multi-dimensional bar code reading device 21. The reader/decoder 20 receives check 10 or some other paper document in a slot 20a presented to the authentication multidimensional bar code device 21. Multiple multidimensional bar code readers/decoders may be included in the unit in order to read and authenticate both the front and/or the backside of the document or check. The Multiple multidimensional bar code readers may include a reader to capture the multi-dimensional properties using a special light source for illuminating the multi-dimensional property.

The reader/decoder unit 20 is connected to a terminal 23 by cable 24. The information from the authentication multidimensional bar code component is displayed on the screen 25 of terminal 23. The operator can immediately determine if the payee is as encoded on the check. The decoded information is displayed and stored into the terminal or a computer connected to the terminal for permanent storage.

An optional signal light 20b (red or green) may be integrated into the mechanical device to alert the operator that a non-visible security feature is included on the check or document. In this manner the operator can respond by viewing the security feature displayed on the terminal screen.

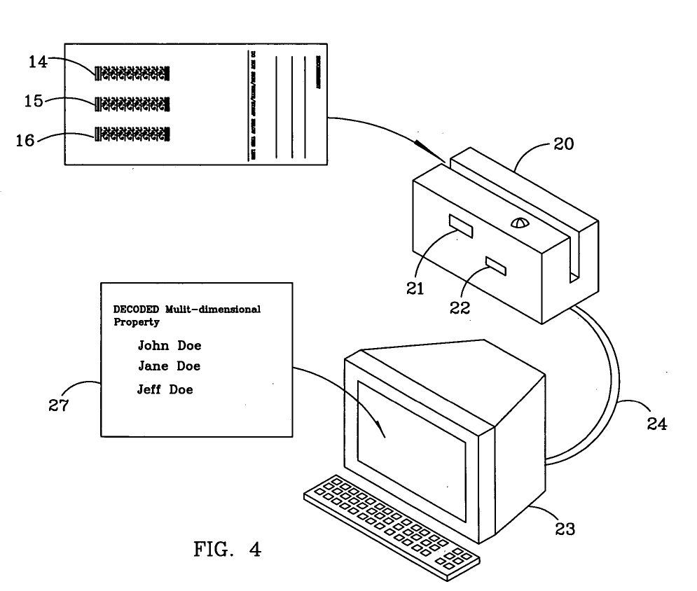

FIG. 4 shows the apparatus of FIG. 3. In this figure, the check 10 is inserted in the reader/decoder unit 20 with the back of the check facing the front of the reader. The multidimensional bar codes 15, 14 and 16 are read to determine the persons authorized to sign the check as encoded in multidimensional bar codes 14, 15 and 15. The authorized person's names are displayed on the terminal 23 screen 27. However, as pointed out above, multiple multidimensional bar code readers (not illustrated) may be placed in reader/decoder unit 20 so that both the front and back of check 10 is read when passed through reader/transport 20 one time.

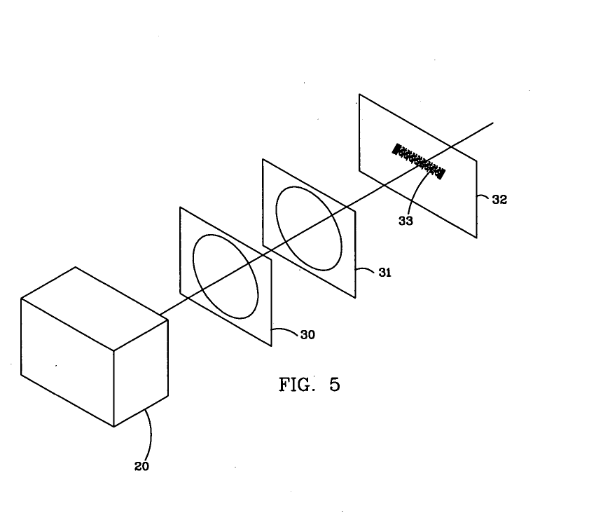

FIG. 5 shows the reader 20, lense and filter required to read the two-dimensional barcode. Reader 20 is also illustrated in FIGS. 3 and 4. Conventional barcodes are one dimensional, in that they are scanned along a line alone the length of the barcode. The barcode is usually a series of vertical lines. The scanning is along the barcode across the vertical lines. A two dimensional barcode, for example a PDF417 barcode, is composed of a plurality of dots arrayed in two directions over an area. The features, or dots, in contrast to the vertical lines in a one-dimensional barcode, are smaller and require a higher resolution in the reader. Also, a one-dimensional barcode is limited to encoding approximately 50 characters or less. The multi dimensional PDF417 barcode can contain up 1024 bytes for a much higher data content. Because of the use of the non-visible fluorescent ink in the present invention also with the multi-dimensional barcode format, a standard barcode reader will not read the fluorescent ink multi-dimensional barcode format of the present invention. In FIG. 5, a standard reader 20 is combined with a correction lens 30 to permit the reader 20 to clearly read the multi-dimensional barcode, and a special filter 31 is used to render the non-visible fluorescent ink visible to reader 20. The combination of reader 20, lense 30, and filter 31 permits the standard reader to read the fluorescent ink multi-dimensional barcode 33 on document 32. Reading of the fluorescent ink multi-dimensional barcode 33 is not possible with current commercial barcode readers. None of the patents researched or presented by the USPO show a device capable of reading/decoding a non-visible multidimensional bar code.

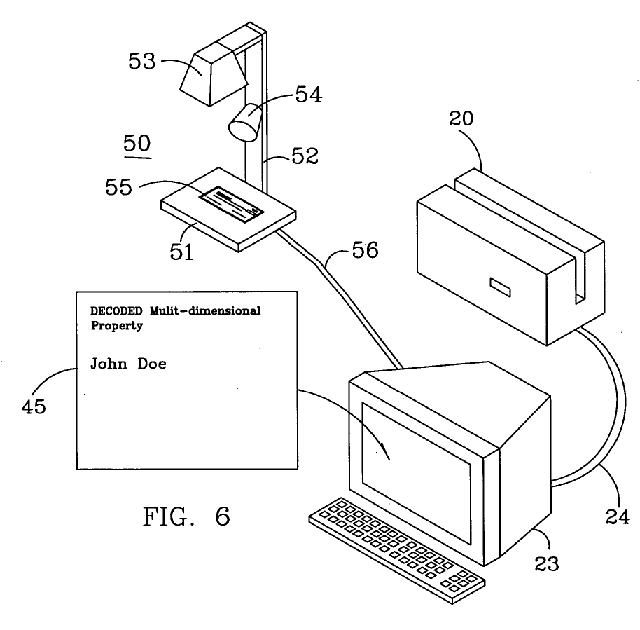

FIG. 6 shows a stand-alone multi-dimensional bar code reader 50. Reader 50 includes, for example, a base 51, with a riser 52 on which is mounted the read head 53, and a light source 54, for example, ultraviolet light, that renders the non-visible ink on check 55 visible to the eye, and to the reader. Reader 50 may be used to read the multi-dimensional property bar code. Reader is 50 connected to computer terminal 23 by cable 56. The check information is displayed on terminal screen 45. Read head 53 includes (not illustrated) the correction lens and filter of FIG. 5.

### Operation of Invention

Corporations, Governments, check manufacturers and individuals with check creation software and printer capability can imprint, with fluorescent or non visible inks, a multidimensional bar code, following the “Pay to” name or designate on their check. The information contained in the multidimensional bar code is a duplication of the designated “Pay to” name on the check. Alternative information may be incorporated in the multidimensional bar code, which may further identify and secure the check document.

Information may also be encoded in the area surrounding the signature field. The information contained in the multidimensional bar code may be a duplication of the authorized signature of the owner or owners of the checking account or secure document.

A multidimensional bar code may also be placed on the backside of a check with fluorescent or non-visible inks. The information contained in the multidimensional bar code may be a duplication of the authorized signature of the owner or owners of the checking account or secure document. Alternative information may be incorporated in the multidimensional bar code, which may further identify and secure the check or document.

These secure documents can be authenticated by Banks, Financial institutions, retail and wholesale establishment utilizing the Check Verification and Authentication Process (CVAP) describe above and illustrated in the FIGS. 1-4.

The operator of the CVAP will present the secure check or documents to the verification and authentication device. The device will accept the document into the “path” for verification to the multidimensional bar code reading device.

The Multidimensional bar code data will be displayed immediately to the operator through the “view station” window on the device and/or transmitted directly to the Personal computer or terminal software application program.

An optional signal light (red or green) may be integrated into the mechanical device to alert the operator that a non-visible security feature is included on the check or document.

The operator will respond by viewing the security feature through the “view station” or accessing the software application that will display the results of the reading/decoding of the non-visible multidimensional bar code on the Personal computer or terminal.

In the “view station” or the Personal computer or terminal, the operator will be able to see the following and make a decision concerning the validity/authentication of the document as follows.

In the “pay to the order” field the operator will be able to compare the non-visible multidimensional bar code data read results with the actual “pay to the order” data on the original check or any data contained in the non-visible multidimensional bar code to secure the data content of the document. In addition the operator will be able to determine if the “pay to the order” field has been altered in any way. The fluorescent ink or non-visible ink will appear distorted or of a low intensity if the check or document has been altered or tampered with in any way. Should the operator identify any discrepancy or alteration in the document, the operator should assume the document to be fraudulent or counterfeit in nature. A “no pay” decision or “hold” decision should be made and the document held for further investigation.

In the “signature” field the operator will be able to compare the multidimensional bar code data with the actual “signature” data on the original check or document. In addition the operator will be able to determine if the “signature” field has been altered in any way. The fluorescent ink or non-visible ink will appear distorted or of a low intensity if the check or document has been altered or tampered with in any way. Should the operator identify any discrepancy or alteration in the document, the operator should assume the document to be fraudulent or counterfeit in nature. A “no pay” decision or “hold” decision should be made and the document held for further investigation.

From the “back side” of the check the operator will be able to compare the multidimensional bar code data with the actual “signature” data on the original check or document. In addition the operator will be able to determine if the “signature” field has been altered in any way. The fluorescent ink or non-visible ink will appear distorted or of a low intensity if the check or document has been altered or tampered with in any way. Should the operator identify any discrepancy or alteration in the document, the operator should assume the document to be fraudulent or counterfeit in nature. A “no pay” decision or “hold” decision should be made and the document held for further investigation.

Also, the above process may be applied to currency security, or any other document data sensitive to fraud or counterfeit, by applying the integration of the non-visible Multi-dimensional bar code device with currency processing and authentication machines.

What is claimed:

1. A method of verification and fraud detection of documents, comprising:
encoding data on a document using a fluorescent encrypted multidimensional bar code;
presenting the document to a reader unit, including a correction lens and filter for reading and decoding the non-visible encrypted multidimensional bar code data; and
displaying the encrypted data.

2. The method of verification according to claim 1, wherein the encoded data is encoded with a non-visible ink.

3. The method of verification according to claim 1, wherein the name of the recipient is encoded with a multidimensional bar code printed in at least one of a fluorescent ink and non-visible ink.

4. The method according to claim 1, wherein the name of at least one person authorized to sign the document is encoded on one side of the document.

5. The method of verification according to claim 4, wherein the name of at least one person authorized to sign the document is encoded with a multidimensional bar code printed in at least one of a fluorescent ink and non-visible ink.

6. A method of verification and fraud detection of documents, comprising:
encoding a document using a fluorescent encrypted multidimensional bar code, the encoding including the name of the document recipient;
encoding the document with the name of a person authorized to sign the document;
presenting the document to a reader/decoder, the reader including a correction lens and filter, for reading and decoding the fluorescent encrypted multidimensional bar code data determining the encoded name of the recipient and person authorized to sign the document; and
displaying the encoded names.

7. The method of verification according to claim 6, wherein the encoded names are encoded with a non-visible ink.

9. The method according to claim 6, wherein the name of at least one person authorized to sign the document is encoded on at least one side of the document.

10. A system for verification of an encoded document, comprising:
a reader/decoder, including a correction lens and filter, for reading encoding on a document, where the encoding is a fluorescent encrypted multidimensional bar code;
a terminal for receiving data read from a document; and
a display for displaying the decoded data from the document to verify data on the document with data encoded on the document.

11. The system according to claim 10, wherein the encoded data is printed in non-visible ink.

12. The system according to claim 10, wherein the fluorescent multidimensional bar code data is read with a standard barcode reader modified with the correction lens and filter reader, and then decoded in the terminal and displayed to compare with data on the document.

13. The system according to claim 10, wherein the reader reads/decodes the multi-dimensional property bar code.
